(19) United States
(12) Patent Application Publication
(10) Pub. No.: US 2002/0023060 A1
(43) Pub. Date: Feb. 21, 2002

(54) Oughta cost purchasing process

(76) Inventors: Timothy J. Cooney, Naperville, IL (US); Raymond Goss, Aurora, IL (US); William Warren, Naperville, IL (US); Thomas Akers, Sleepy Hollow, IL (US); Jason Hollar, Auror, IL (US)

Correspondence Address: NAVISTAR INTERNATIONAL, TRANSPORTATION CORP., 455 CITYFRONT PLAZA DR., LAW OFFICES-13, CHICAGO, IL, 60611, US

(21) Appl. No.: 09/832,603

(22) Filed: Apr. 11, 2001

Related U.S. Application Data
(60) Provisional application No. 60/198,906, filed on Apr. 20, 2000.

(51) Int. Cl. G06F 17/00

(52) U.S. Cl. 705/400

(57) ABSTRACT

A computer system for developing what the cost of a part ought to be. The system is based upon the assumption that the firm seeking to have a part manufactured for it is a world-class competitor and, thus, in order to maintain this status, it must purchase parts from suppliers who are also world-class competitors. The oughta cost of the part assumes that the best manufacturing practices will be used, the best design, manufacturing practices, supply chain management techniques, labor rates, uptimes and yields will be employed and the selected supplier will continue to push itself to be the best in its industry. The system can generate very detailed reports showing how the ought-to-be cost was determined. These reports will be used in open fact driven discussions with the supplier and the traditional method of requesting quotes, factor cost analysis and target costing will be eliminated. Once the purchaser and supplier have reached an agreement on what the cost of a component or process ought to be an agreement on price that enable both to prosper as world class concerns becomes an easy step because both have the mutual incentive to be and partner with world class organizations.

### BACKGROUND OF THE INVENTION

The need for a process, such as “Oughta Cost,” is the competitive nature of business today. There is significant pressure on cost, and the firms that will survive in the future will align themselves with suppliers/partners that will commit to developing and utilizing the world's best processes to insure that they are the least cost producer.

Traditionally, when a firm or business desires to have a part made for them by a supplier, they would provide a number of potential suppliers with a disclosure of the part and other relevant information and ask them to submit a quote. However, a quoting process such as this merely provides prices at which the suppliers wish to sell the part and there is no rational basis to assume that the quoted price is based upon what the cost to produce the part is or, for that matter, is the price competitive. Under the traditional quoting process, three quotes were obtained and the lowest quote was accepted. Under more informed systems, the lowest quote becomes the price from which a final price is negotiated. Regardless of what followed the submission of quotes, there is no guarantee that the final price is based upon what the cost to manufacture the part “ought to be.” Even if the supplier provides data explaining how the quoted price was arrived at, there is no assurance that the data is accurate. Furthermore, there is no assurance that the best design, manufacturing practices, supply chain management techniques, labor rates, uptimes and yields will be employed to produce the part. Most buyers, and most sellers for that matter, do not know what the “lowest possible cost” is for the product they are buying (or selling),

Thus, the traditional “quote process” does not address the question of what the cost of the part ought to be or whether the product, service or process will have a best of class quality. Product, service or process cost is usually derived from the standard cost system or a job order cost system both of which have a number of faults that prevent them from being reliable sources for determining what the cost ought to be. For example, standard cost usually is an average cost for a number of products, processes or services. Thus, the lowest quote is not necessarily what the cost of the part ought to be. Factors that affect what the cost of a part ought to be includes the design itself, the purchase cost of materials, the quality of the part, the productivity of the manufacturing process, the location of the manufacturing facility and the labor and operating cost. These and other factors must be considered in determining the cost. Manufacturers need to purchase from and partner with those suppliers that commit to utilizing world class processes.

The current process used to arrive at the final cost is heavily dependent on negotiating skills. The negotiation skills vary widely among a firm's individual buyers. The “Oughta Cost” process approaches the cost based on facts and significantly diminishes the role of negotiation in the determination of the costs. This represents another major focus and objective of the “Oughta Cost” process.

The objective of this invention is to provide a system by which a firm seeking quotes from other firms to supply parts can, themselves, determine what the cost of a part ought to be assuming that the supplier uses the best design, manufacturing practices, supply chain management techniques, labor rates, uptimes and yields. This new and improved system can be used to determine what the cost ought to be for an existing part or process and also for a new part that has not yet been manufactured on a production basis. Therefore, the outcome of the ultimate cost will be a fact-based discussion instead of reliance on the best negotiator.

Once the facts are agreed upon, this process also forms the basis for future cost reductions as the process is improved. This is important since this process will identify the best practices and help the supplier drive toward this target.

### BRIEF SUMMARY OF THE INVENTION

This invention is based upon the assumption that the firm seeking the quote is a world class competitor and, thus, in order to maintain this status, it must purchase parts from suppliers who are also world-class competitors. As a result, the suppliers must utilize the best design, manufacturing practices, supply chain management techniques, labor rates, uptimes and yields in order to profitably supply parts at a price that is based upon the ought-to-be cost. In other words, for a firm to maintain its status as a world-class competitor, it must do business with supply firms who continually push themselves to be the best in their industry and lead or keep up with technological changes in their industry.

The fundamental concept of the “Oughta Cost” process is to develop the lowest cost potential for a part. The process to determine this cost facilitates a situation in which the supplier or suppliers will work with the purchaser to develop a state-of-art design, using the best design, manufacturing practices, location, energy cost, transportation, supply chain management techniques, labor rates, uptimes and yields for the type of part being manufactured. The process will also provide the selected suppliers with the incentive to push themselves to be the best in their industry.

It should be noted that this program is intended to determine what the cost of a part ought to be and not what its sale price ought to be. The supplier of the part would, of course, add to the cost an amount that represents his profit.

The first step in establishing what the cost of a particular part ought to be is for a technically qualified individual to review the engineering drawing and/or an actual prototype of the part for which the ought-to-be cost is sought. However, a team of people, for example people who specialize in finance, purchasing, manufacturing and materials, are needed to support the process. The technical individual must be competent to appreciate the function of the part, the environment and the conditions under which it must perform. This individual must also be familiar with state-of-the-art manufacturing processes so that the best manufacturing process for the part can be selected. Furthermore, this individual must be competent in supply chain management, i.e., just-in-time delivery systems. Most importantly, this individual should coordinate or champion the process. However he/she does not have to possess all of the skills and can rely upon contributions from the team. For current production parts much of what is needed is already at the disposal of the individual who will perform this initial step. For example, piece part drawings, prototype parts, quality samples and Pre-Production Process Prove-out Program results are all available to the individual performing this task. Much of the necessary information can be derived from the available material.

It should be noted that although the specific embodiment of this invention disclosed and discussed herein relates to the production of a part, this process can also be used for process analysis, for example for developing an accounts payable process.

In reality, the technically qualified individual may actually be several individuals from different disciplines of the organization. For example, product engineers, manufacturing experts, logistics experts, financial experts and purchasing experts may all contribute to the development of what the cost ought to be for a particular part or process. It is contemplated that the computer program for this invention will be networked so that it will be available to all those in the organization that may contribute to or use the final results. Thus, different screens for a particular component may be inputted by different individuals.

A computer program having a number of computer screens has been developed which enables an operator or operators to develop what the cost of a part ought to be. The program includes separate screens for Material, Labor, Capital, Manufacturing, Overhead and Reports. The computer screens have pull down menus that, for example, will allow the operator to select appropriate items by merely clicking on them. The screens may also include fields into which the operator will input data that has been calculated for this specific part. These and other methods for inputting data are interchangeable and a screen disclosed herein having a field into which an operator can input data could be changed to a pull down menu if and when sufficient data is available without departing from the practice of this invention.

The Labor Section, for example, includes several pull down menus listing various skilled tradesmen, best in class pay scales and the cost of their benefits. Factors will be included for scrap and rework and the material cost will be calculated. Best in class labor rates, both direct and indirect, will be applied to the times determined for the manufacturing process and a factor for employee benefits will be added to determine total hourly cost. It is important in applying this process that best in class practices, processes, labor rates, uptimes and yields are used to guard against the potential supplier basing their cost figures on their current processes. The “Oughta Cost” process must focus potential suppliers on staying current with the best in class approach for every phase of the process. This will direct the potential suppliers to achieve a best in class status. Other costs, such as inventory carrying costs, interest, amortization, cutting tool expenses and engineering will all be considered in establishing what the cost ought to be.

Since it is anticipated that the supplier may have to acquire new machines or even new facilities in order to meet the oughta cost target, a Capital section has been included in the program. The Capital section allows the input of capital investments that are required for machines and increase capacity to manufacture the part, and the computer program will then compute the amount of depreciation to be charged to each part. The results of these calculations will also be used when inputting data to the Overhead screen.

The program includes a Manufacturing Screen where the required volume for the component being processed is inputted and the uptime for current and World class manufacturing machines can be selected from drop down menus or data bases. This screen also includes fields for entering the required manufacturing time as well as work days per year, work shifts per day, and work hours per shift that will be required to accomplish the manufacturing task. When all the fields of the Manufacturing Screen have been entered and stored, the section is totaled and the next category is available for selection. However, if a screen is being worked on but has not been completed, if a new screen is selected all data that has been entered in the uncompleted screen is automatically saved.

The Overhead Screen displays the total depreciation for capital assets required to manufacture each component selected. Also displayed on this screen is the portion of depreciation consumed by that part. General overhead is applied by selecting a percentage from a drop down menu in the Additional Expenses section. Overhead rates can be modified at any time if it is determined that additions and/or deletions are required. When all items of a screen have been selected and stored, the line items are stored and another screen can be selected.

A Reports Section has been included in the program. This section is used to select desired reports for partial or complete report on the process. This can be done for a part or a group of components that make up a part. If necessary, components' costs can be refined by evaluating effect of changes to one or more of the elements making up the total cost and re-running reports to determine the optimal Oughta cost target.

The system makes various calculations using data that has been inputted into a study. The following are formulas, that are imbedded in the program, and used by the program to calculate other weights, values, cost, requirements, benefits, wages, depreciation, times, rates, prices, profits and, cost:

Piece Weight=(Yield Weight+Fabrication Waste Weight)/(1−Scrap Rate)

Fabrication Waste Weight=(Yield Weight/(1−Fabrication Waste Rate))−Yield Weight

Total Material Cost=Raw Material Cost Per Piece×Total Number Pieces Required+Total Freight Cost

Total Freight Cost=Per Piece Freight Cost×Total Number of Pieces Required+Dunage+Insurance

Total Number of Pieces Required=Number of Good Pieces/(1−Manufacture Scrap Rate)

Per Piece Raw Material Cost=(Raw Material Weight per Piece/Unit Weight)×Unit Price

Per Piece Freight Cost=Shipping Wt. In Units×Freight Rate per Unit (for mode & distance)/(1−Manufacture Scrap Rate)

Total Labor Cost=Total Direct Labor Cost+Total Non-direct Labor Cost (Skilled Trades Support+Indirect)+Total Direct Benefits+Total Non-Direct Benefits

Total Direct Labor Cost=Direct Labor Wages+Direct Labor Benefits

Salaried Cost=Annual Salary×# Required

Salaried Benefits=Annual Salary Benefits×# Required

Direct Labor Wages=(# Equivalent Labor Type 1 Required×Wages 1×Hours Worked per Year)+(# Equivalent Labor Type 2 Required×Wages 2×Hours Worked per Year)+(# Equivalent Labor Type n Required×Wages n×Hours Worked per Year)

Direct Labor Benefits (# On-Roll Labor Type 1 Required×Benefits per Person)+(# On-Roll Labor Type 2 Required×Benefits 2 per Person)+(# On-Roll Labor Type n Required per Person)

Total Non-direct Labor Cost=Non-direct Labor Wages+Non-direct Labor Benefits

Total Non-direct Labor Wages=(# Equivalent Skilled Trade 1 Required×Wages 1×Hours Worked per Year)+(# Equivalent Skilled Trade 2 Required×Wages 2×Hours Worked per Year)+(# Equivalent Skilled Trade n Required×Wages n×Hours Worked per Year)+(# Equivalent Indirect 1 Required×Wages 1×Hours Worked per Year)+(# Equivalent Indirect 2 Required×Wages 2×Hours Worked per Year)+(# Equivalent Indirect n Required×Wages n×Hours Worked per Year)

Total Indirect Labor Benefits=(# On-Roll Skilled Trade 1 Required×Benefits per Person)+(# On-Roll Skilled Trade 2 Required×Benefits 2 per Person)+(# On-Roll Skilled Trade n Required×Benefits n per Person)+(# On-Roll Indirect 1 Required×Benefits 1 per Person)+(# On-Roll Indirect 2 Required×Benefits 2 per Person)+(# On-Roll Indirect n Required×Benefits n per Person)

Per Piece Direct Labor Wage Cost=Direct Labor Wages 1/# Good Pieces Produced per Year)+(Direct Labor Wages 2/# Good Pieces Produced per Year)+(Direct Labor Wages n/# Good Pieces Produced per Year)

Per Piece Direct Labor Benefits Cost=(Direct Labor Benefits 1/# Good Pieces Produced per Year)+(Direct Labor Benefits 2/# Good Pieces Produced per Year)+(Direct Labor Benefits n/# Good Pieces Produced per Year)

Per Piece Indirect Labor Cost=(Total Non-direct Labor Wage Cost 1/# Good Pieces Produced per Year)+(Total Non-direct Labor Wage Cost 2/# Good Pieces Produced per Year)+(Total Non-direct Labor Wage Cost n/# Good Pieces Produced per Year)

Per Piece Indirect Labor Benefits Cost=(Total Non-direct Labor Benefits 1/# Good Pieces Produced per Year)+(Total Non-direct Labor Benefits 2/# Good Pieces Produced per Year)+(Total Non-direct Labor Benefits n/# Good Pieces Produced per Year)

Capital Depreciation=General Capital Cost $/Useful Life (years)+Machining Capital Cost/Useful Life (years)

Capital Depreciation Attributed to a Part=Capital Depreciation/Annual Capacity in Pieces

Available Manufacture Time=(Number Work DaysNear)×Hours per Day (For Each Piece of Equipment)

Percent Uptime=Net Good Pieces per Scheduled Unit of Time/Max. Number of Good Pieces per Scheduled Unit of Machine Time×100

Per Piece Manufacture Time=Machine Type 1×Cycle Time (1+2+n)+Machine Type 2×Cycle Time (1+2+Equipment Type n/Equipment n Uptime

Capacity at Theoretical Equipment Utilization Rate=Manufacture Time Available/Cycle Time

Capacity at Best in Class Equipment Utilization Rate=Manufacture Time Available/Cycle Time×World Class Uptime

Capacity Potential (Additional # Pieces)=Manufacture Time Available/Cycle Time×(World Class Uptime−Current Uptime)

Total Overhead=General Overhead+Utilities+Warranty+Engineering Support+Indirect Materials

Where: General Overhead is expressed as % of Labor & Material, or, if information exists, as a dollar amount Utilities expressed as % of Labor & Material, or, if information exists, as a dollar amount Indirect Materials as Assumed $ amount per Direct Labor Hour, or, if information exists, as a specific dollar amount.

Total Manufacturing Cost=Total Labor Cost+Material Cost+General Overhead+Utilities+Indirect Material+Depreciation

Total Engineering Cost=% of Total Manufacturing Cost

Total Warranty=% Total Manufacturing Cost

Per Piece Overhead=Total Overhead/Volume Good Pieces

Inventory Carrying Interest Cost=Annual % Interest Rate×(Manufacturing Cost−Depreciation)×Average # Days Inventory

Per Piece Inventory Carrying Cost=Inventory Carrying Interest Cost/Volume (Good Pieces)

Total Purchase Price=Per Piece Purchase Price×Volume

Purchase Price=Oughta Cost+Gross Profit

Gross Profit is added to Oughta Cost and includes profit before income taxes startup costs, etc.

Project Oughta Cost=Part 1 Oughta Cost+Part 2 Oughta Cost+Part n Oughta Cost

Oughta Cost of an Assembly=Component 1 Oughta Cost+Component 2 Oughta Cost+Component n Oughta Cost+Assembly Oughta Cost+Shipping Oughta Cost (if buying an assembly)

Total Oughta Cost of a Component=Material Cost (Including Freight)+Labor (Direct & Non-direct) +Depreciation (Plant & Equipment)+Total Overhead

The program for determining what the cost of a part ought to be has numerous benefits, some of which are:

it informs the user of the program what the part or the change in the part should actually cost;

it provides a parts buyer with all of the factual information required to negotiate a fair business deal;

it provides a method to define and recognize areas of future improvement;

it provides a path to attain world class pricing;

it eliminates the mystery of whether a fair price was obtained;

it gives a firm control over its own destiny;

both parties become focused on attaining the lowest cost (win/win) vs. the traditional win/lose process;

reduces the dependency on the negotiating skills of the buyer;

it takes the guesswork out of costing and design changes;

it eliminates the practice of a supplier initially quoting a low price and then attempting to raise the price;

it eliminates the practice of a supplier initially quoting a high price and lowering it in increments until the customer accepts a price that is higher than it ought to be;

it provides the user of the program the opportunity to build their price structure from the ground up rather than from where the firm is currently paying for a similar part;

it provides a better understanding and trust in the results since it is fact based;

it substantially shortens the time involved to arrive at the product, process or service cost;

it provides the cost based upon the supplier using the best practices and, if the supplier is not using the best practices, this program provides the impetus for improvement; and

it provides the basis for developing a solid target cost.

it provides the supplier the opportunity to use this process with their supply base.

it provides confidence that the firms using this process will be world class competitive.

After the cost that a part ought to be has been determined, through the use of this invention, discussions can then be initiated with potential suppliers. Although, in some situations the supplier would be involved in the development of the cost. If the part is one that is currently being supplied at a price in excess of that dictated by the ought-to-be cost, discussions with the supplier would be initiated. The manufacturing processes and the supply chain management techniques used to develop the ought-to-be cost, along with all other data that went into the ought-to-be cost, would be fully disclosed. The supplier would be given the opportunity to explain how his price was arrived at and the individual components of the two total costs would be compared. In this way, it would become apparent which components are responsible for the differences. For example, if the supplier includes a figure for delivering the part to the purchaser that is considerably higher than the amount used for delivering in the ought to cost total, then this cost would be scrutinized by both parties. The result may be that the supplier could engage a different carrier or open a new facility closer to the customer and reduce this cost. Another possibility may be that the supplier is using obsolete methods or tools, and his cost could be brought in line with the ought to cost figure if he used a new process and new machines. Once the purchaser and supplier have reached an agreement on what the cost of a component or process ought to be an agreement on price that enable both to prosper as world class concerns becomes an easy step because both have the mutual incentive to be and partner with world class organizations. Another benefit to the supplier will be that the improvements that this process has on them will be attractive to other customers, as well as their own supply base, and their business will grow and become more profitable.

### BRIEF DESCRIPTION OF SEVERAL VIEWS OF THE DRAWINGS

FIG. 1A is the upper part of a system diagram that depicts the architecture used for determining what the cost of a part ought to be.

FIG. 1B is the lower part of a system diagram that depicts the architecture used for determining what the cost of a part ought to be.

FIG. 2 is an index screen for the program including a drop down menu from which existing reports or partial reports can be selected.

FIG. 3 is the Material screen with the Material Type drop down menu open.

FIG. 4 is the Material screen with the Supplier Scrap drop down menu open.

FIG. 5 is the Material screen with the Fabrication Waste drop down menu open.

FIG. 6 is the Material screen with the Mode drop down menu open.

FIG. 7 is the completed Material screen.

FIG. 8 is the Labor screen after all data for a component has been entered.

FIG. 9 is the completed Capital screen.

FIG. 10 is the Manufacturing screen with the Uptime Current drop down menu open.

FIG. 11 is the Manufacturing screen with the Uptime World Class drop down menu open.

FIG. 12 is the Manufacturing screen with the Scrap Rate drop down menu open.

FIG. 13 is the Manufacturing Screen with data entered in the Manufacturing Time fields.

FIG. 14 is the completed Manufacturing screen.

FIG. 15 is the Overhead screen with the data for the Depreciation filled in and the Warranty Cost drop down menu open.

FIG. 16 is another view of the Overhead screen with the Cost Category drop down menu open.

FIG. 17 is the Reports screen shown with the Program Number drop down menu open.

FIG. 18 is the Reports screen displaying the information that identifies the Report that is being requested and with the drop down menu open that provides the options for what should be done with the Report that has been requested.

### DETAILED DESCRIPTION OF THE INVENTION

Although this invention is susceptible of being presented in embodiments of many different forms, there is shown in the drawings, and will be discussed in detail, a specific embodiment thereof with the understanding that the present disclosure is to be considered as an exemplification of the principles of the invention and is not intended to limit the invention to the specific embodiment illustrated. The specific embodiment has been developed on a variety of commercially available software programs and servers.

The decision to use this program to perform an Oughta cost analysis could be made for various reasons. It could involve a new part/process or an existing part/process. When such a decision is made, the decision is recorded in the program and the next Program Number is assigned to the particular request. A project champion is assigned to the particular request who selects a team that typically will include a person from Engineering, Manufacturing, Purchasing and Finance. However, team members will vary depending on the product, service or process to be analyzed. An initial team meeting would generally be scheduled at which the team examines the product, service or process to be analyzed and costed. If available, data such as product prints, prototype parts and standard information would be made available and discussed at such a meeting as well as the development or purchase of custom information required for this particular analysis. In some situations, for example, if the part is new and the design is not yet fixed, the team may decide that a supplier or suppliers should be consulted at this stage. If additional data is required, appropriate members of the team are assigned the task of acquiring such data. Components of the part to be analyzed would be identified and Component Control Numbers assigned which for existing parts could be the part number. The Component Control Number carries forward on all screens and for all the data relative to the component being costed for use in other screens, if applicable, and for the report section. Assignments would be given to the team members at this meeting which could be a meeting at which those involve are actually gathered together or an auto or video conference or combination of the above. The necessary data for the data entry fields would be prepared and loaded into the program.

After all necessary data has been prepared and ready to be loaded into the program team members can log on to the system and input the information discussed and collected at the team meeting. One person can be designated to maintain the entire system or sections can be assigned to several team members for input. Default data, displayed from drop down menus or in data tables which are supplied from data bases either purchased or built internally. All data base driven data can be overridden and then used only for the particular study for which it was overridden. Although the system implies a sequence, which will be followed in the following example, it is not necessary to strictly follow the sequence. For example, the Capital Section could be completed prior to the Material Section.

In some situations, it may be possible for a single operator, for example, a buyer, to accurately select and enter all the data requested as you proceed through the program. However, in most situations, contributions from other disciplines, such as manufacturing, engineering, reliability, material handling and finance will be required. For this reason, the system is provided on a network to which the personnel from all necessary disciplines have access. The security of the system would, of course, be protected by the use of passwords or other conventional methods. The security for the system can also be protected such that once data has been entered, it can be hidden or viewed but not changed by all but a selected group.

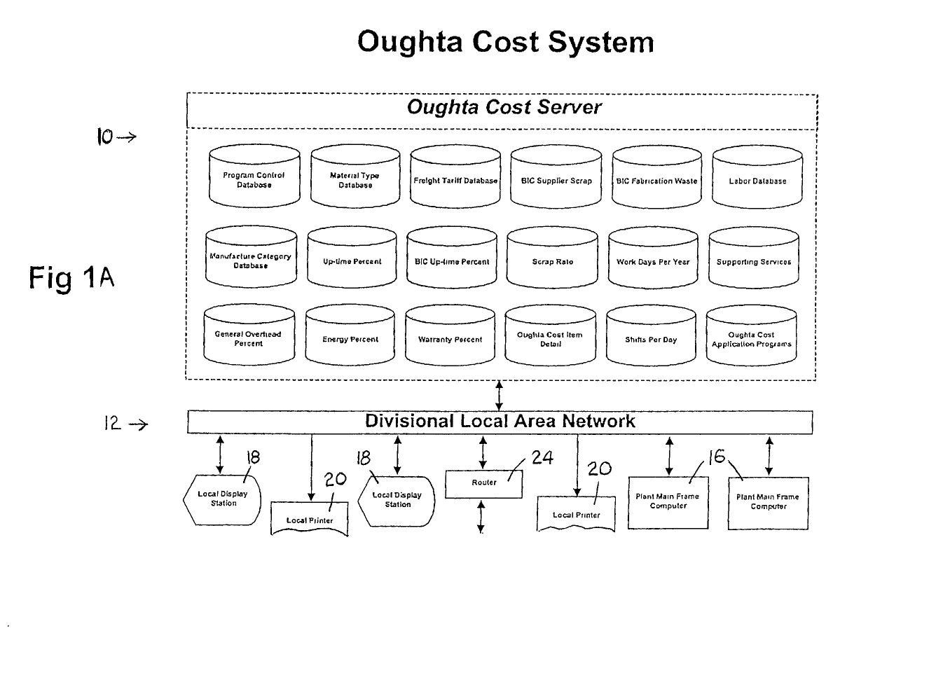

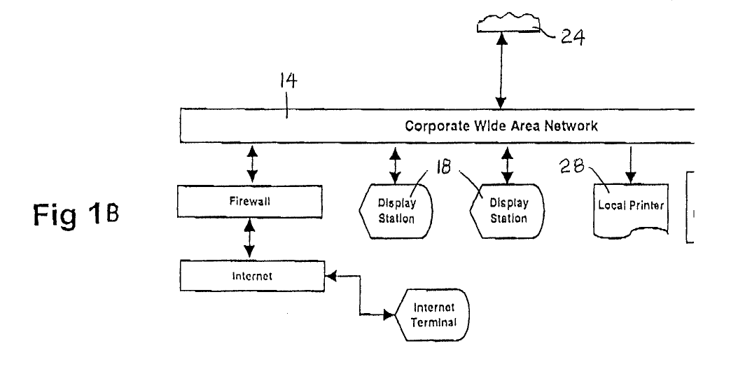

FIGS. 1A and 1B when combined discloses a preferred embodiment of a system diagram. This preferred embodiment depicting the Oughta Cost system server 10, the Local Area Network 12, the Wide Area Network 14, the internet connection and other computers/systems available on the network. To view this complete system FIG. 1B should be placed below FIG. 1A. The router 24, that is shown in both FIGS. 1A and FIG. 1B, interconnects the Divisional Local Area Network to the Corporate Wide Area Network. The system server 10 includes the application programs and the various databases that are utilized by the system. As seen in FIG. 1A the name of some of the databases contained in the system server 10 include the prefix “BIC” which is an acronym for BEST IN CLASS. Some of these databases will be created specifically for this system while other databases will be purchased from private or public sources. Also, it should be noted that the databases used in the preferred embodiment discussed herein are identified in FIG. 1A, however for other embodiments and other parts or processes other or additional databases would be required. Individuals from various disciplines such as Engineering, Manufacturing, Accounting, Purchasing and Transportation will contribute and use this system. Individuals located at the plant are served by a local area network 12. These individuals will utilize local display stations 18 to access the Ought Cost system, gather additional information from the plant Main Frame Computer 16 and use local printers 20 to print reports. Other contributors and users of the system in remote locations will use their local facilities and display stations to input data, display information and print reports from their local printers 28 from the Oughta Cost system. All corporate locations are connected to a wide area network and are provided access to the Oughta Cost system through a router 24 that links the local area network with the wide area network. The linkage of the two networks allows local, remote and external access into the Ought Cost system. Also the plant Main Frame Computer 16 and the Corporate Main Frame Computer 22 are tied together providing an extended pool of data available to all Oughta Cost Users.

Although a preferred embodiment of the system server is illustrated FIGS. 1A and 1B other embodiments could of course be developed. Although the preferred embodiment utilizes a conventional computer having a monitor or a plasma panel and a keyboard and/or mouse it is contemplated that the program could be provided in a miniature computer that could be held in the palm of the users hand. The network disclosed herein could also communicate with external databases such as a data base that provides the prime rate or other rates that change. The term “part,” as used in this application, can mean a complete part or a component of a part that is comprised of several parts. If the part that it is desired to determine its ought-to-be cost was comprised, for example, by a shaft, a housing and a bearing block, then the process would be run for each of the three components and perhaps a fourth run for assembling the three components.

The process for determining what the cost of a part ought to be can be best understood through an example that will be presented with respect to a shaft that is made from a steel forging that is machined. However, it should be understood that the process can be conducted for any part/process made by any process. Furthermore, the “Oughta Cost” process is equally applicable to what the cost of a process or a service ought to be and thus can also be used in the service industry.

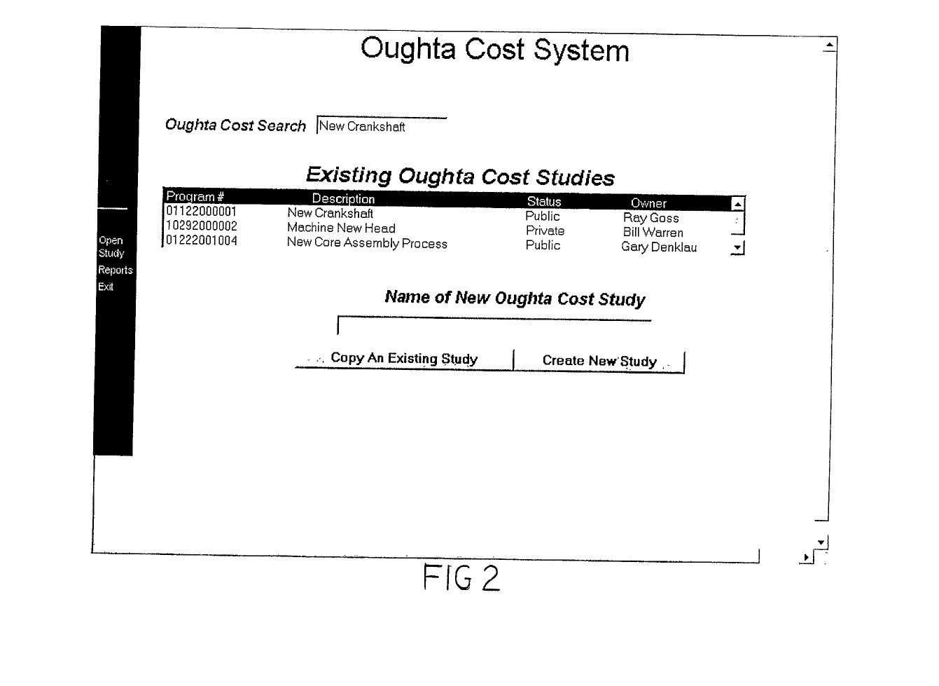

FIGS. 2 through 18 are illustrations of the computer screens that can be selected from the computer program and into which cost components are inputted. All of the screens of this program are interactive thus if an improvement is made in a screen that has been completed, the screen can be updated and the chance will be reflected in all other applicable screens.

FIG. 2 is an index screen that is displayed after the Oughta Cost Program has been accessed. This screen includes an Oughta Cost Search section, that will allow a person using the system to perform a search of fields of the system that include descriptive words of the description of existing studies. In the screen shown in FIG. 2 “New Crankshaft” has been entered in the search box and three existing studies have been identified that include the search term in the fields that are searched. This feature will not only allow specific Studies to be located but it will also existing Studies to be found that are similar to a new study that is about to be undertaken. The existing Study can then be copied and used as a starting point for the new Study. If a copy of one or more of the existing Studies is desired the operator highlights the desired existing Study and clicks on the Copy An Existing Study button.

Rather than using the Oughta Cost Search feature an operator could scan through the entire list of Existing Studies that is available in the Existing Oughta Cost Studies section seen in FIG. 2. For each of the Existing Studies the following information is displayed in columns in this screen: Program #, Description, Status and Owner. As each new study is initiated it is assigned a Program # and the operator will be prompted to provide a descriptive name for the study. As Studies are developed they will be assigned a status. For example a Study that is classified as Public may be viewed and printed out by anyone on the system, however unless the individual is on an authorized list they would not be permitted to maintain or make changes to the Study. Only development team members designated by the owner are allowed o maintain a study. Other Studies may include confidential information that it is important to limit its disclosure to a certain group of individuals. Such a Study would be classified as Private and access for any purpose to a Private Study is limited to a certain group of individuals. The owner of a particular could be for example the person that was named to coordinate and “Champion” the process or the study or it could be a group or division within the enterprise that controls this collection of Studies. The columns could be sorted which could for example place all Studies having the same Owner together.

If more information about a particular Study contained in the Existing Oughta Cost Studies list is needed to make a selection, the description can be clicked and the next level of detail is brought up.

The screen shown in FIG. 2 also includes a box into which the name of a new Oughta Cost Study can be imputed as well as a button that can be clicked to have the system create the new Study. After the button for creating a new study has been clicked, key field information must be added. The system will assign the program number and component codes as they are requested

The solid vertical area on left of the screen, in this example, is a menu bar that offers the following four options appear: Open, Study, Reports and Exit. One of these options can be selected, for the project that has been selected in the Existing Oughta Cost Studies section, by clicking on the option in the menu bar. For example if the “New Crankshaft” program is selected in the Existing Oughta Cost Studies section, that program can be opened by clicking on “Open” in the menu bar.

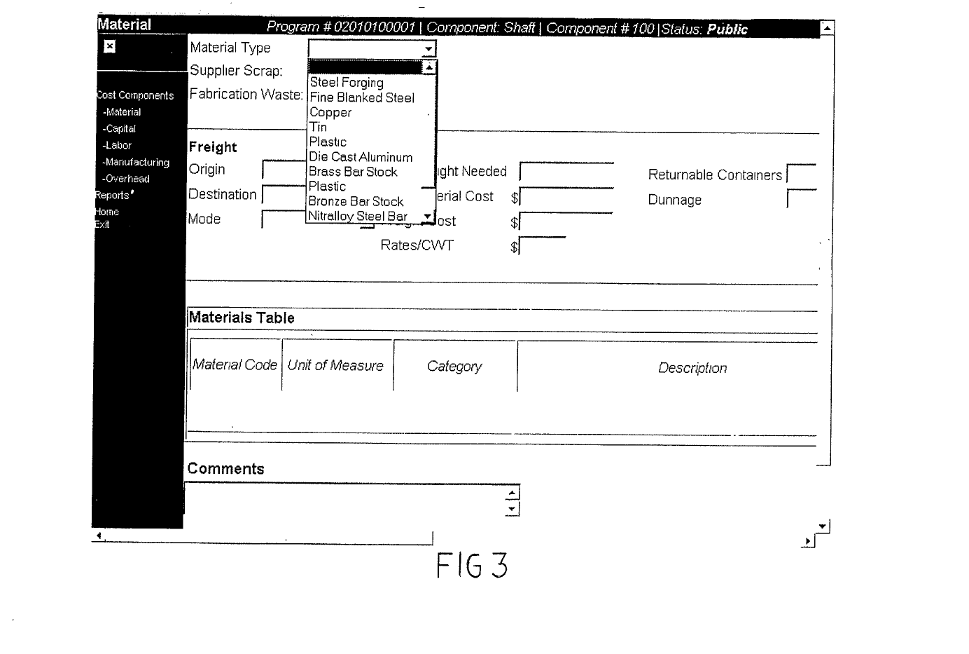

The Material screen is intended to collect data for a single component. If the study contains more than component, each one will be linked by program number and must individually. The Material screen has been selected, from the New Crankshaft program and is shown in FIG. 3. As seen in FIG. 3, Material Type has been selected which produces a drop down menu containing a variety of Material Types. Steel Forging has been selected and, upon clicking on the Select button, that selection will be entered. Also identifies in FIG. 3 are the six screens that are included in this embodiment of the invention. It should be understood that other embodiments of the invention could include more or fewer screens. The six screens identified in the solid vertical menu bar on left of the FIG. 3 screen are Material, Capital, Labor, Manufacturing, Overhead, and Reports. To select one of these screens, click on the appropriate selection in the solid vertical menu bar. The desired screen could, of course, be selected in other ways, for example, by double clicking.

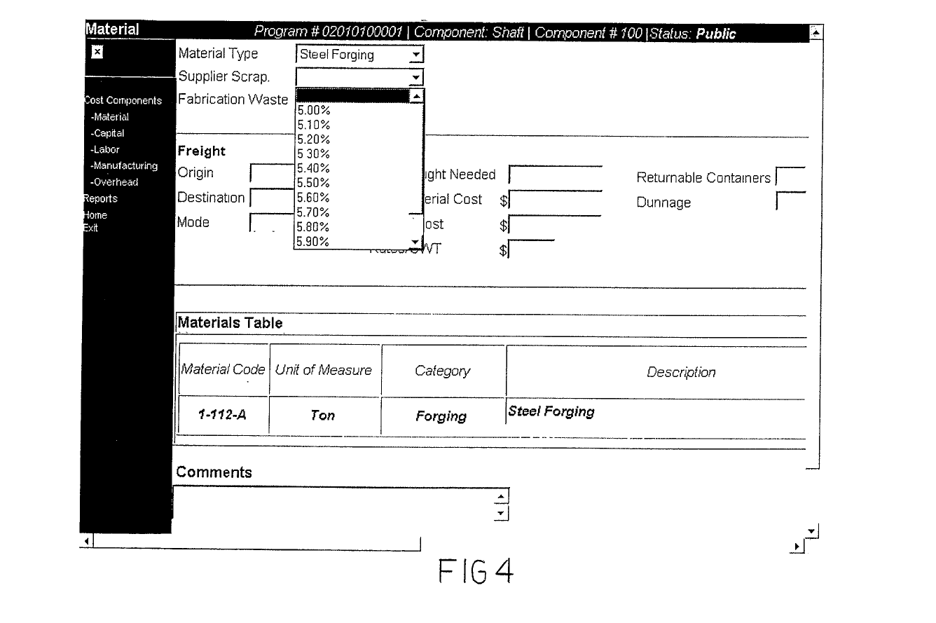

The Material screen, as seen in FIG. 3, includes a Material Table at the bottom of the screen. As seen in FIG. 4, as a result of selecting Steel Forging in FIG. 3, information will automatically populates the Material Table section. This information informs the operator that the unit of measure for a unit of this material is tons and the category of this material is a Steel Forging. Also seen in FIG. 4 the drop down menu for Supplier Scrap has been opened. The drop down menu containing a variety of percentages. The drop down menus generally include a default selection which is the figure for the Best in Class for subject of the drop down menu. The operator has the option to accept the default best in class supplier scrap rate or select another percentage, assuming there is a basis for doing so. The operator has selected 5.00% by clicking on it. This selection, which is the “best in class” default percent was made after examining the actual part, model or drawing as well as the cost per unit.

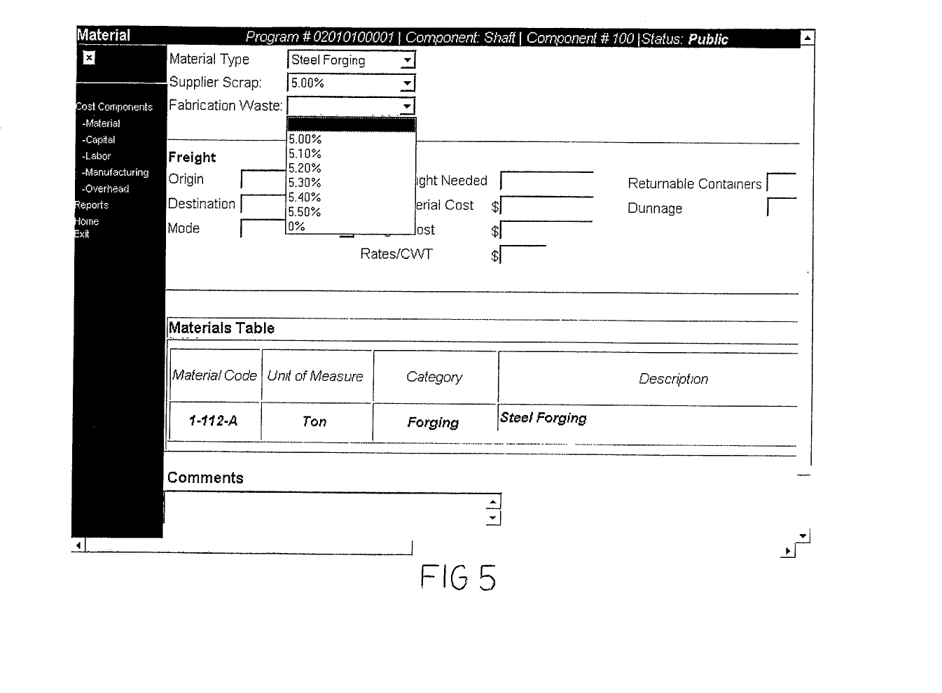

The Material screen is again shown again in FIG. 5. In this screen, the prior two selections are shown and the operator has selected Fabrication Waste which produces a drop down menu of percentages. The data for this drop down menu could be a purchased or an internally developed data base. Again the operator has the option to select the default best in class fabrication waste rate or select a rate. The operator has selected the highlighted “best in class” rate of 5%. Once the material yield weight, supplier scrap rate and fabrication waste rate has been entered, the system will calculate the total item weight needed.

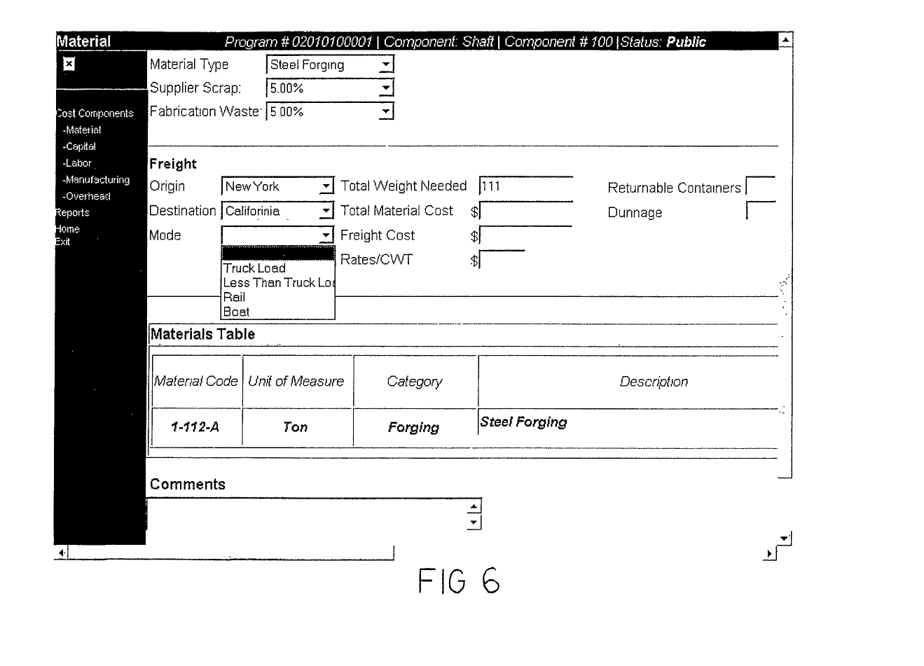

As seen in FIG. 6, the operator's previous selections of 5.00% for Supplier Scrap and Fabrication Waste are displayed shown and the system has calculated and inputted into the Total Weight Needed field 111 pounds. Freight Rates/CWT has been selected and the drop down menu is open and can be seen in FIG. 6.

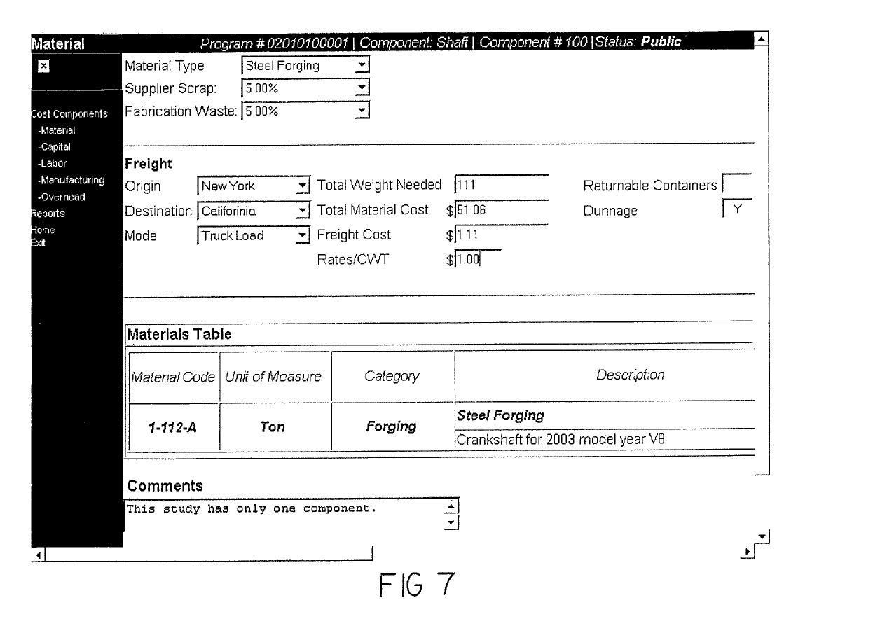

As seen in FIG. 7, the Freight Rate/CWT of 1.00 representing the best in class rate was selected. The computer program has also calculated that the cost of the material will be $49.95 (not shown) and the Freight Cost will be $1.11 is calculated. The program adds these cost and displays $51.06 as the Total Material Cost in the appropriate field.

In the Freight section of the Material screen seen in FIG. 7, in the box for “Dunnage” the letter “Y” (for yes) has been imputed. Either Retiurnable Containers or Dunnage must be picked to complete the material section. If “Returnable Containers” is chosen, additional labor data must be provided on the labor screen to capture the costs associated with manaing the containers. If “Dunnage” is chosen then the additional labor will not be displayed.

It should also be noted in the Material Table of the Material screen, seen in FIG. 7, there is a Description area. In the Description area the term “Steel Forging” appears and below that term “Crankshaft for 2003 model year V8” appears. As seen in the Material screen, FIG. 3, the term “Steel Forging” was selected from a drop down menu. Since the drop down menu includes only broad categories the program includes a field into which the operator can input a much more descriptive term. In this example the operator has inputted “Crankshaft for 2003 model year V8”.

FIG. 7 shows the Material screen completed and it is now saved to the database. If the part includes other components, for example, a housing, a fresh Material screen would be selected and an alpha suffix, or any other suffix, would be added to the original component number that was assigned. The above process would than be completed for this component. When the material screens for all of the components have been completed and saved in the database, another set of screens is initiated.

Although not shown in the material Screen illustrated in FIGS. 3-7 additional fields could be provided. For example fields for the Raw Material Weight, Casting/Forging Weight, Stamping Weight and Net Machined Weight as well as the unit or units of measure could be provided on the Material Screen. Information for such fields could be found in the engineering drawings and or sample component and this information could be entered in the appropriate fields by the operator.

All of the screens in the system have a “Comments” section into which operators can place relevant comments and or assumptions.

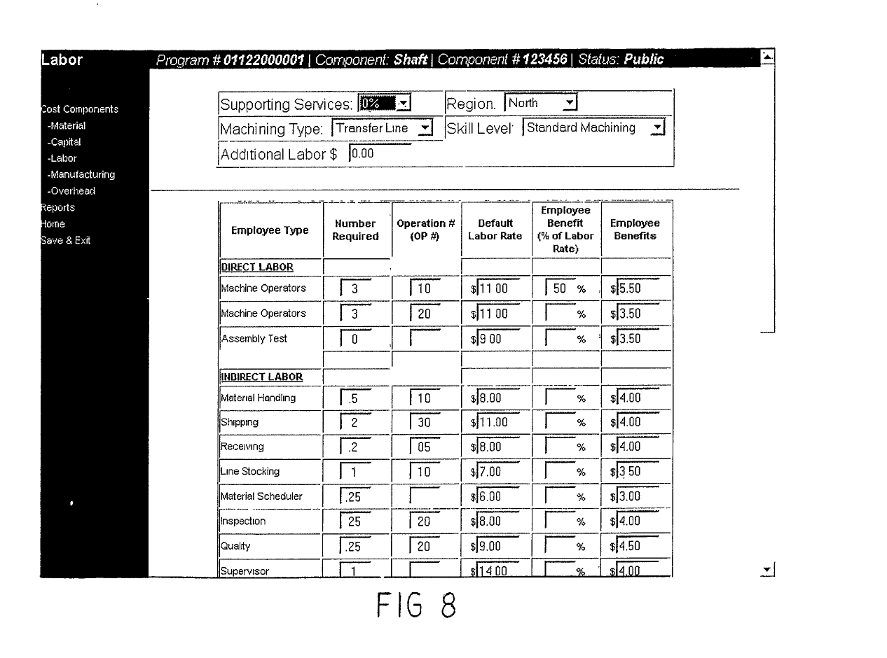

FIG. 8 shows a completed Labor screen and indicates that it is the screen for the component Shaft. This screen includes sections for Supporting Services, Machining Type, Additional Labor, Region and Skill Level. Each of these sections has a drop down menu and a selection has been made where appropriate. For example the North region and a Standard Machining Skill Level have been selected from the drop down menus. The supporting Services dropdown menu's default value is zero which is only used when specific data, either actual numbers or data provided from a database, in not available.

The Labor screen seen in FIG. 8 also includes sections for DIRECT Labor and INDIRECT Labor. These sections include fields such as Default Labor Rate and Employee Benefit as both a percent of the Labor Rate and as a dollar figure. For data such as this drop down menus may not be practical and the data must be entered by the operator. However, defaults values as well as the best in class default rates for direct, indirect and skill trades labor will be provided in the data base and displayed to the operator. Modifications can be made to all defaults and new defaults figures added to the program if desired. When it becomes necessary to track and keep separate multi-tier labor cost, a button is provided that when selected, assigns a suffix to the control number for each tier. The type of part or process being processed helps in the determination of which labor rate is used, i.e., if it is an engineered highly technical part with tight tolerances, then machine operators with greater skills and higher labor rates are designated. The Labor Screen allows adds, changes and deletes so that it can more accurately reflect the current world class numbers, mixes and associated labor rates of the employees. For example, 3 Machine Operators has been inputted.

However, if labor operations are needed for more than one level of skilled labor to manufacture the part, then means can be taken to address secondary labor operations. Once completed, the Labor files will be saved to the database. The Labor section can be modified at any time if it is determined that additions and/or deletions are required. However, if a screen is being worked on but has not been completed, if a new screen is selected all data that has been entered in the uncompleted screen is automatically saved.

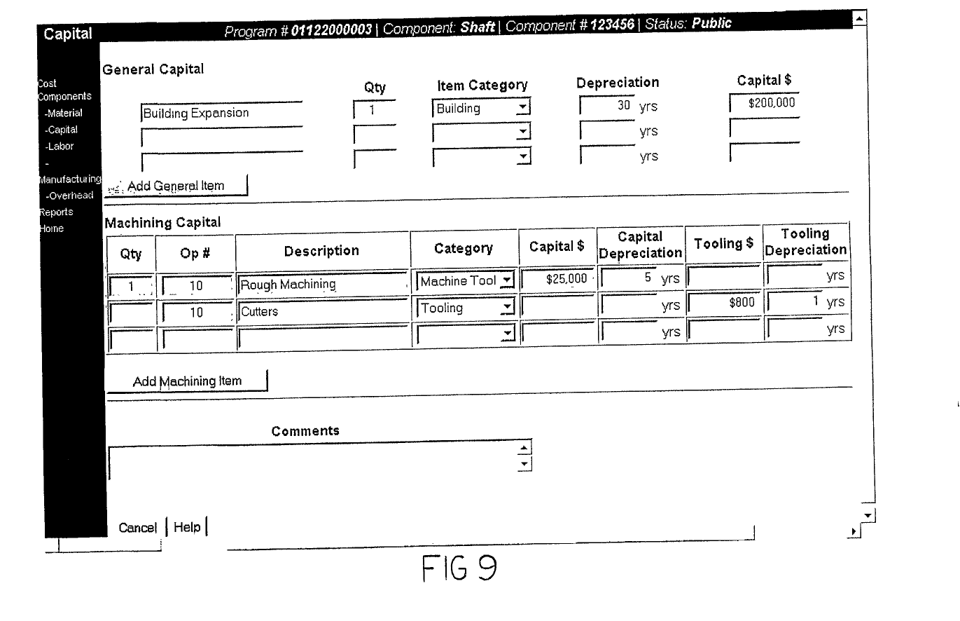

A completed Capital Screen is shown in FIG. 9. The system will supply the Program Number while other items are key entered utilizing best practice process or processes and most suitable location or locations. This screen allows the manual input of individual capital items required to manufacture each component selected however it is contemplated that a database will be provided that would provide best in class data for items such as cost of different types of equipment, square-foot cost of green field plant construction by region and cost of furnishings. The system uses the capital items in this section to calculate depreciation that appears in the Overhead screen which will be discussed in a subsequent portion of the specification. Capital can be modified at any time if it is determined that additions and/or deletions are required, The Capital Screen has sections for General Capital and Machining Capital. In the General Capital section, dollar amounts have been inputted for Building Expansion, Furniture and a PC. In the Machining Capital, dollar amounts have been inputted for Rough Cut, Drill and Final Cut.

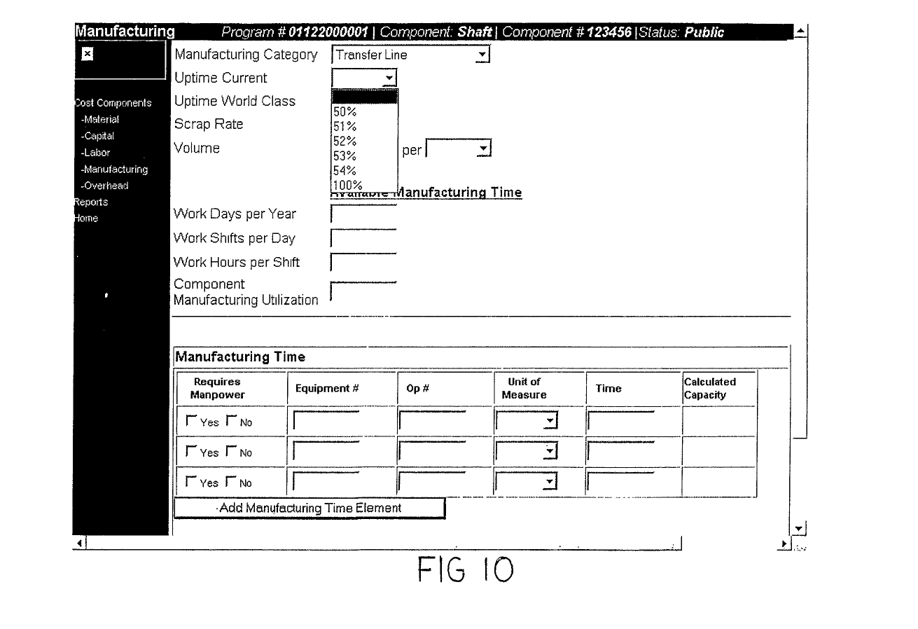

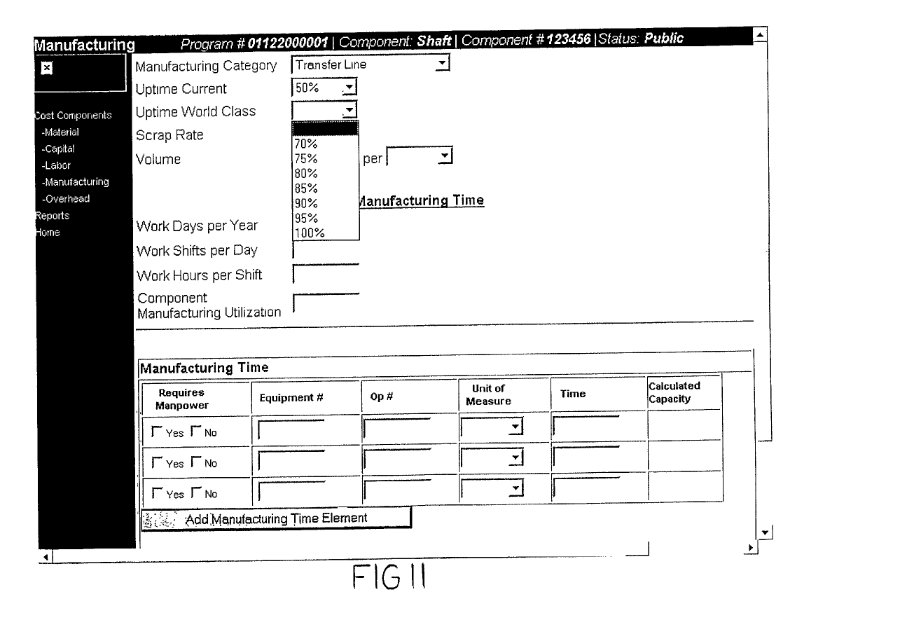

The Manufacturing section is separated into three areas: general, Available Manufacturing Time and Manufacturing Time Elements. The Manufacturing Screen for the Shaft is shown in FIG. 10, the Manufacturing Category of “Transfer Line” has been entered and the drop down menu for Uptime Current % has been opened. Since this field assumes that there is an existing process, this field will not be applicable in some situations—i.e. new parts, new plants, new processes. As seen in FIG. 11, which is another view of the Manufacturing screen, the operator has selected 50% from the Uptime Current drop down menu and the drop down menu for the Uptime World Class has been opened.

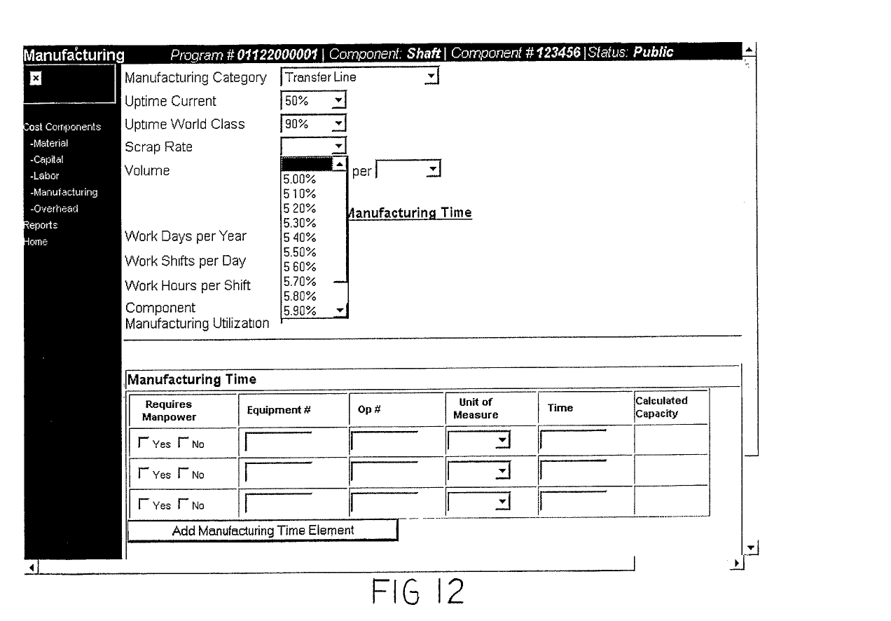

FIG. 12 is another view of the Manufacturing screen. In this view it can be seen that the operator selected 90% from the Uptime World Class drop down menu. The World Class uptime can be determined by the type of equipment being considered The default value is 90%, but can be overwritten if the World Class value changes. Eventually, the default will be displayed rather than selected. It should be understood that the cycle times used for this process are tied to the world class uptime/process and not to the current uptime. This particular section is only used when the program is calling for the current machine to be replaced by a World Class machine. The Scrap Rate drop down menu has been opened in FIG. 12.

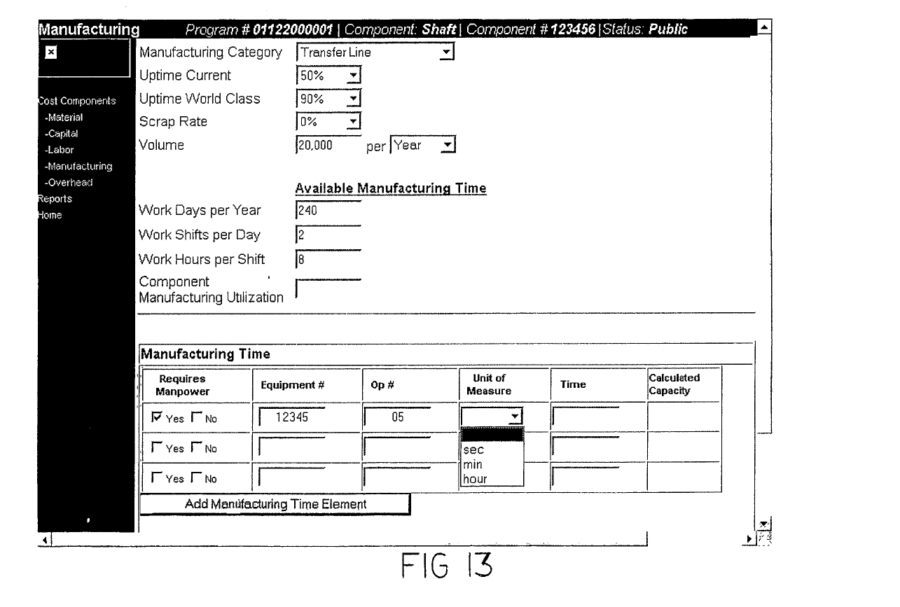

FIG. 13 is another view of the Manufacturing screen. In this view it can be seen that the operator selected 0% from the Scrap Rate drop down menu. Also a volume of 20,000 has been inputted in the Volume field and the “year” has been selected by the operator from the drop down menu for per. In this screen data has also been entered indicating that there will be 240 Work Days per Year, 2 Work Shifts per Day and 8 hour Work days per shift. In the Manufacturing Time portion of this screen the operator has inputted that this process Requires Manpower, the Equipment Number is 12345 and the number of operators required is 2. In FIG. 13 the Unit of Measure drop down menu has been opened and the options sec, min and hour are displayed.

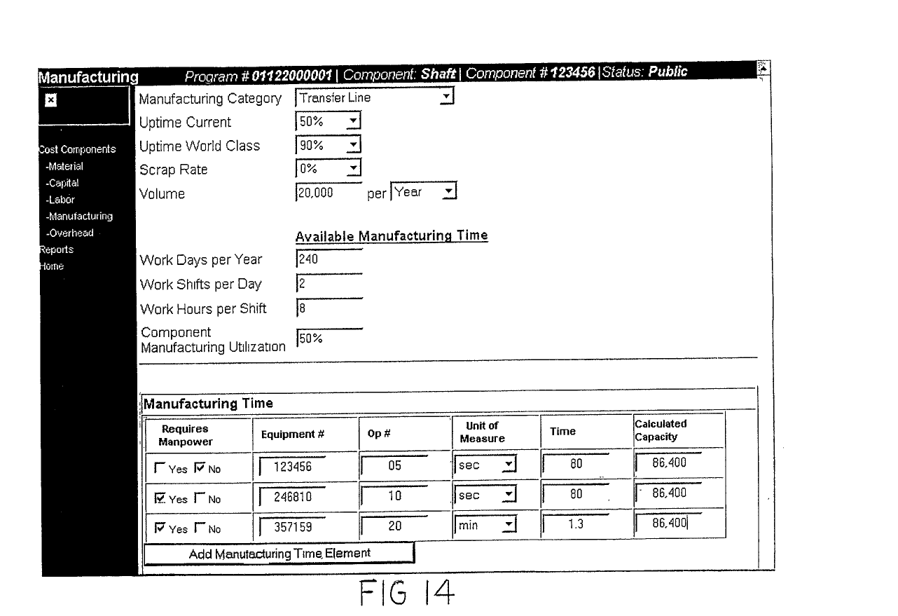

FIG. 14 is the completed Manufacturing screen. In should be noted that in this screen there are three visible lines for inputting Manufacturing Time Elements. However, an unlimited number of Manufacturing Time Elements can be entered into the system. In FIG. 14 three new Manufacturing Time Elements have been entered which are visible in the screen seen in FIG. 14. The Manufacturing Time Element #12345 that is seen in FIG. 13 is not seen in FIG. 14, however although not visible in the screen it remains in the system and will be included in all calculations and could be recalled to be viewed or modified if desired. In FIG. 14 the Component Manufacturing Utilization has been inputted as 50% and the data for additional Manufacturing Time Elements numbers 123456, 246810 and 357159 have been keyed in and the system has calculated the Capacities. This screen is now completed and will be saved in the database.

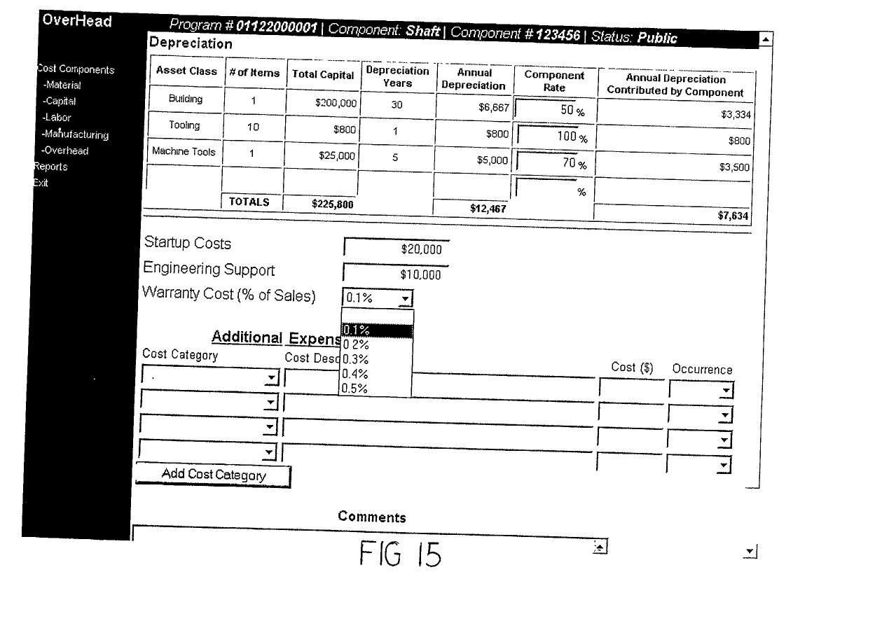

The Overhead Screen for the Shaft is shown in FIG. 15. The overhead section captures miscellaneous expenses, depreciation and startup costs. Depreciation costs for each asset is collected in a table contained in this screen. Asset Class and Asset Value are carried forward from the Capital screen and automatically entered in this screen. Class and component Depreciation are calculated once the Depreciation Schedule and the component utilization rate have been specified. The depreciation schedule is determined by the equipments “useful life.” The equipments useful life is defined as the lesser of the time it will take for the equipment to wear out or the technical obsoleteness of the products produced by the equipment. In this screen, the depreciation data for Building, Tooling and Machine Tools has been inputted in the Depreciation table. For the Machine Tools, the annual depreciation is $5,000. However, its Component Rate is 70% and, thus, 70% or $3,500 will be charged to this project. The total depreciation to be charged to this component is inputted as $7,634. The Startup Cost of $20,000 and Engineering Support of $10,000 have been inputted into this screen. The Warranty Cost as a % of Sales has a drop down menu that is shown open in FIG. 15. The operator has selected 0.1% from the drop down menu.

The Overhead Screen also has an Additional Expenses section. There are four visible lines in the screen for entering Additional Expenses. However, the system can accommodate additional Cost Category. If there are more than four such Cost Category the operator clicks on the “Add Cost Category” and additional lines are made available by the program.

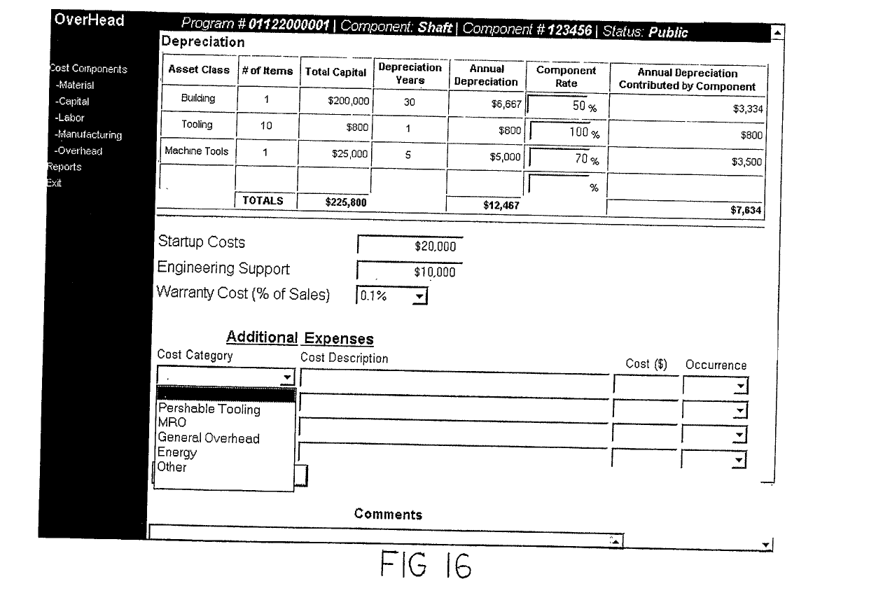

FIG. 16 is another view of the Overhead screen in which the drop down menu for the first Cost Category has been opened. This menu has the following options: Pershable Tooling, Maintenance, Repair, and Operating Supplies (MRO), General Overhead, Energy and Other. This screen is now completed and will be saved in the database.

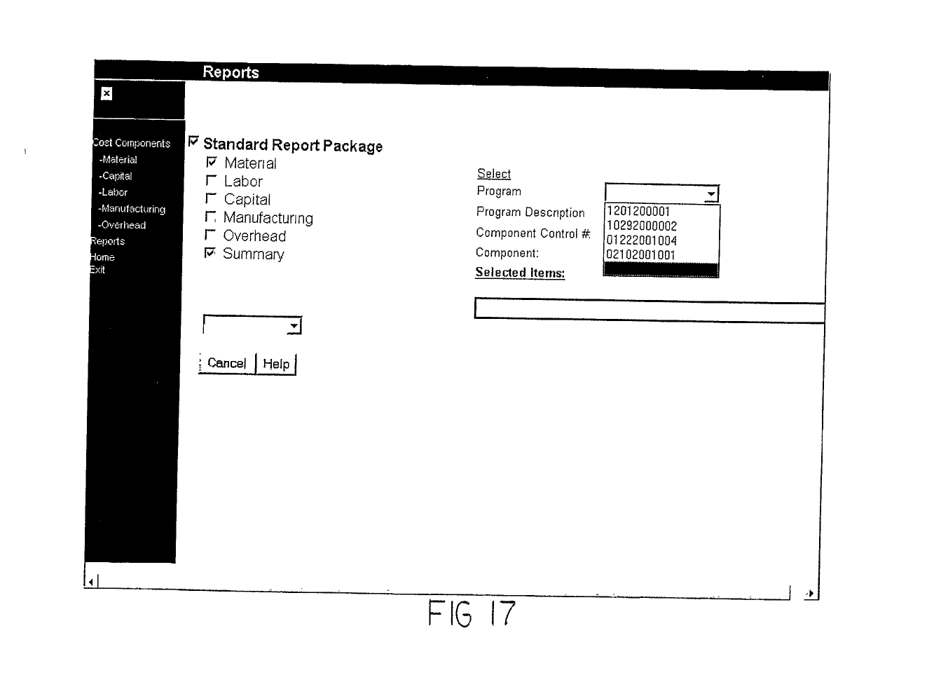

The final screen, the Report Screen, is shown in FIG. 17. This section is used to select for print the standard Oughta Cost package or selected sections. Reports can be generated for the entire study, a component, a group of components or an assembly. This section allows for a wide variety of reports to be generated for one or multiple items by checking the appropriate box or boxes. The reports can then be viewed, printed or saved to a file for future analysis or dissemination. Reports can be produced for a part or a group of parts and from one or more sections or to the complete package. If necessary, component costs can be refined by evaluating effect of changes to one or more of the elements making up the total cost and re-running reports to determine if the desired results were achieved. Changes can be made to the program by selecting the Existing Costing Program option. Once all the inputs have been made, the Report screen can be selected, Program Number selected and a particular report can be requested. In FIG. 17 the Program drop down menu has been opened and the menu displays the programs that are available.

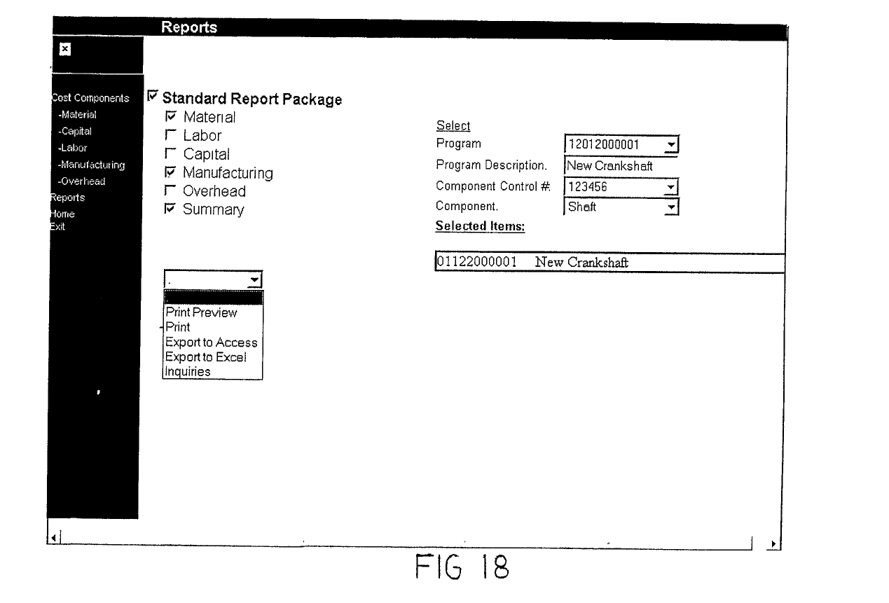

FIG. 18 is another view of the Reports screen in which is displayed the inputted information that identifies the Report that is being requested and an opened drop down menu that provides the options of what can be done with the Report that will be generated. The options on the drop down menu are: Print Preview, Print, Export to Access, Export to Excel and Inquiries.

After all screens have been completed the Oughta cost team reviews the outputs from the system to ensure all inputs have been collected and have been accurately reflected. If the team determines that additional information is now available and is germane to the study, the team could input the additional data into the system. Outputs would then be created with the new information.

When the Oughta cost team is satisfied with the results, and the supplier has not participated, the results of the study would then be shared with the supplier for review so that cost discussions will occur based on facts rather than negotiating skill. In some instances suppliers will disagree with some of the facts upon which the study is based. Discussions between the purchaser and the supplier can then be conducted to resolve these fact issues. Further research and discussions may be necessary to resolve differences however these discussions relate to factual matters that can be resolved to the satisfaction of both sides. When a supply agreement is finalized the complete results of the study are provided to the supplier for their use in providing the part or service.

This invention has been described in terms of a specific embodiment and for a single component. However, those skilled in the art will appreciate that the invention can be practiced with modifications within the spirit and scope of the appended claims. Thus, changes can be made in form and detail without departing from the spirit and scope of the invention.

Accordingly, all such changes are to be considered within the scope of the present invention and the invention encompasses the subject matter of the claims which follow.

What is claimed is:

1. A method of doing business in which the cost of a component, service or process is established by:
using a computerized process that includes data bases from which aspects of the cost, provided best in class design, manufacturing practices, supply chain management techniques, labor rates, uptimes and yields are utilized, can be determined;
generating reports from said computerized process that include details of each aspect of the cost;
providing the reports to prospective suppliers of the component or service;
conducting discussions, with the prospective suppliers of the component or service, in an effort to gain concurrence on the fact basis of what the cost of the component or process ought to be;
conducting fact based discussions, with prospective suppliers of the component or service with whom concurrence on the cost has been reached, in an effort to reach an agreement on what the price of the component or process will be to enable both the buyer and seller to prosper as world class businesses.

2. In a networked computerized system, a method of determining what the cost of a part or service ought to be provided world class practices, processes, labor rates, uptimes and yields are used, the method comprising:
establishing databases of cost components for producing parts and services that will, when totaled, be what the cost of the part ought to be provided the best design, manufacturing practices, supply chain management techniques, labor rates, uptimes and yields are followed;
providing a database interface for the database that will allow remote access by one or more users;
establishing a set of computer screens, including input fields into which cost components can be inputted either directly or through menus that display options from said database that can be selected, each screen concentrating on a cost area such as material, labor, capital, manufacturing and overhead;
totaling the inputted figures and rates for each screen, make any necessary calculations and store the subtotal for each screen; and
totaling all of said subtotals which is the ought to be cost of the part or service.

3. In the method as set forth in claim 2 wherein the following further step is performed:
printing out a report for a screen describing the components of the screen and the inputted amounts and the subtotal for the screen.

4. In the method as set forth in claim 2 wherein the following further step is performed:
printing out a report for all screen describing the components of each screen, the inputted amounts for each component, the subtotal for each screen and a total for all screens.

5. A computer system for determining what the cost of a part or service ought to be including a computer system accessible on a network to authorized users of the network, said computer system comprising;
a computer program that, has fields into which cost data can be manually entered, can interface with a database or databases and can be accessed by one or more users, said computer program being programmed to perform computations on data that has been imputed manually or from a database;
a database, that can interface with said computer program, containing cost components for parts;
a set of computer screens for said computer program including input fields into which cost components can be inputted and menus that display list of cost components from said database that can be selected, each screen concentrating on a cost area such as material, labor, capital, machining or overhead;
said computer program having the capability to total all inputted cost components, make any necessary calculations and store the subtotal for each screen; and
said computer program having the capability to total all of said subtotals which is the ought to be cost of the part or service.

6. In a computer system as set forth in claim 5 wherein the computer program has the capability to print out a report for a screen describing the components of the screen, the inputted amounts and the subtotal for the screen.

7. In a computer system as set forth in claim 5 wherein the computer program has the capability to print out a report for all screens describing the components of each screen, the inputted amounts for each component, the subtotal for each screen and a total for all screens.

8. A method of using a computer to develop a factual report that will be used in fact driven discussions with a supplier in an effort to establish what the cost of the part or service ought to be, comprising the steps of:
identifying and quantifying the cost components of a part or step of a process that, when totaled, determine what the cost of the part or process ought to be provided the best design, manufacturing practices, supply chain management techniques, labor rates, uptimes and yields are followed;
inputting into the computer all cost components that are necessary to determine what the cost ought to be for each component of the part or step of the process;
totaling all cost components and making all necessary calculations for each part or step in a process and recording this as a subtotal;
totaling all of said subtotals, which is what the cost ought to be, for the part or process provided the best design, manufacturing practices, supply chain management techniques, labor rates, uptimes and yields are followed;
outputting from the computer program a report that specifies the cost of each part or process and how each component of this cost was established; and
utilizing this report in cost driven discussions with a supplier to obtain an agreement with the supplier to provide parts or services at a price that is based upon the ought-to-be cost.

9. A method of using a computer to facilitate identifying and quantifying cost components of a part or service, the total of which is what the cost ought to be provided the best design, manufacturing practices, supply chain management techniques, labor rates, uptimes and yields are followed, comprising the following steps:
providing a computer program that can interface with a database, said computer program being available on a network that will allow remote access by one or more users;
establishing a database that interfaces with said computer program, the database containing fact based cost components that are needed to calculate what the cost ought to be provided the best design, manufacturing practices, supply chain management techniques, labor rates, uptimes and yields are followed;
establishing a set of computer screens for said computer program including input fields into which component cost can be inputted and menus that display options of component cost from said database, each screen concentrating on a cost area such as material, labor, capital, manufacturing and overhead;
providing said computer program with the capability to total all inputted cost components, make any necessary calculations and store the subtotal for each screen; and
providing said computer program with the capability to total all of said subtotals which is the ought-to-be cost of the part or service.

10. In the method of using a computer as set forth in claim 9 wherein the following further step is performed:
printing out a report for a screen describing the components of the screen, the inputted amounts and the subtotal for the screen.

11. In the method of using a computer as set forth in claim 9 wherein the following further step is performed:
printing out a report for all screens describing the components of each screen, the inputted amounts for each component, the subtotal for each screen and a total for all screens.
